(19) United States
(12) Patent Application Publication
(10) Pub. No.: US 2004/0182777 A1
(43) Pub. Date: Sep. 23, 2004

(54) Filtration module including unitary filter cartridge-bowl construction

(76) Inventors: Ralph J. Stankowski, Westford, MA (US); David Stockbower, Woburn, MA (US)

Correspondence Address: Timothy J King, Mykrolis Corporation, 129 Concord Road, Billerica, MA, 01821, US

(21) Appl. No.: 10/481,781

(22) PCT Filed: Jun. 10, 2002
(86) PCT No.: PCT/US02/18515

Related U.S. Application Data
(60) Provisional application No. 60/301,709, filed on Jun. 28, 2001.

(51) Int. Cl. B01D 27/00; B01D 35/00

(52) U.S. Cl. 210/455; 210/435; 210/443; 210/321.6

(57) ABSTRACT

A filtration module is provided which includes a manifold, a filtration cartridge and a bowl that houses the filter cartridge. The filtration cartridge and bowl are connected to each other by a key and a mating keyway to form a unitary construction. The filtration cartridge and bowl are in fluid communication with the manifold in a manner which prevents mixing of a fluid feed to the module and a permeate removed from the module.

### BACKGROUND OF THE INVENTION

The present invention relates to membrane filtration modules that are more sanitary and are easier to replace and install than presently available filtration modules. More particularly, the present invention relates to membrane filtration modules formed from a filtration cartridge, retaining bowl and manifold together.

The control of particulate contaminants in a filtration process such as in the semiconductor industry requires the use of ultraclean filters having membranes that remove submicron particles. It is well known that any particle that is deposited on a semi-conductor wafer produces a defect when the particle is sufficiently large. Typically in the semi-conductor industry, failed defects can be produced by particles as small as about one tenth of the smallest features of the semiconductor chip. Therefore, membrane filters are used in every process step for producing semiconductor chips to purify both working liquids and gases.

Although many different designs have been developed for a filtration module used in an ultrapure liquid filtration, two designs are prevalent. In one module design, liquid to be filtered flows from one end of the filtration module to the other end. In this class of the filtration modules, the feed and permeate connections are located at opposite ends of the filter thereby forcing the liquid flow to move from one end to the other end. This flow configuration is referred to as an in line flow configuration. These filtration modules suffer from two disadvantages. First, they are more difficult to connect to the process equipment since the module is sandwiched between two sets of connections. Second, any free liquid remaining within the module quickly drains upon disconnection of the module because at least one connection is positioned at the bottom of the module.

A second filtration modular design locates all of the connections at the same end of the module. In this type of module, the feed and permeate ports are typically horizontally oriented at the top or “head” end of the module on opposite sides thereof. Due to their shape, these modules are referred to as having a T, L or U configuration. This configuration facilitates connection of the head to the remaining portion of the filtration module comprising the bowl and the filtration cartridge positioned within the bowl. In this design, the bowl and filtration cartridge comprise separate elements. Thus, when constructing the filtration module, the filtration cartridge and the bowl are separately secured to and sealed to the manifold head. In addition, upon completion of filtration the bowl and cartridge are separately removed from the head. This separate removal requires that the bowl be moved a distance substantially greater than the entire length of the cartridge in order to expose the cartridge to permit its removal. Thereafter, the exposed cartridge is removed by hand or with a hand tool. Since the filter cartridge is saturated with the liquid being filtered which is often times corrosive or toxic, the cartridge removal step presents a danger to the worker. In addition, since the bowl must be moved the length of the cartridge, the space within which the bowl and cartridge are positioned must accommodate this removal step.

It has been proposed in U.S. Pat. No. 5,114,572 to provide a filter assembly which cooperates with a bowl to produce a filter cartridge-bowl construction which can be demounted as a single unit from a manifold. The filter cartridge is connected to the bowl by bayonet connections on the cartridge which fit into grooves within the interior surface of the bowl. This bayonet connection requires the flanges extending from the outside surface of the filter cartridge be positioned into grooves that extend vertically within the bowl and then into grooves which extend horizontally within the bowl. The connection configuration requires that the cartridge first be moved vertically into the vertical grooves and then be rotated into the horizontal grooves when mounting the cartridge into the bowl. Conversely, when it is desired to remove the cartridge from the bowl upon completion of a filtration process, the cartridge must be rotated and lifted from the bowl in a single motion. Since removal of the cartridge from the bowl requires application of force on the fluid conduit located at the top of the cartridge, and since the diameter of this conduit is smaller than the cartridge diameter there is no leverage of the application force on the cartridge. This, in turn, requires application of considerable force on the cartridge when effecting its removal from the bowl that may require the use of hand held tool. The application of a rotational force and a lifting force as a single motion increases the difficulty of separating the bowl from the filter cartridge. Separation of the cartridge from the bowl is particularly difficult when toxic or corrosive fluids have been filtered by this filtration device.

Further, current designs have the cartridge seal against and be lightly (friction fit) held to the manifold. Any application of back pressure when applied to the cartridge can cause the cartridge to unseat from the manifold, rendering it ineffective for filtration.

Accordingly, it would be desirable to provide a filtration module construction which avoids the need to remove the filtration cartridge separately than the bowl from the manifold while permitting the filter cartridge and bowl to be removed from a manifold as a single unit. In addition, it would be desirable to provide such a construction that avoids the need for applying force in a plurality of directions of movement to effect removal of a cartridge and bowl from a manifold. Such a construction would promote ease of separating the cartridge and bowl from the manifold, would eliminate the danger to the worker in removing the filtration cartridge subsequent to filtration and would reduce the space required to install the filtration module. Lastly, by forming the cartridge and the bowl as a unitary structure and securing that structure to the manifold, the problem of the cartridge becoming dislodged from the manifold when subjected to back pressure is avoided.

### SUMMARY OF THE INVENTION

In accordance with this invention, a filtration module is provided comprising a manifold, and the combination of a filtration cartridge and bowl wherein the filtration cartridge and bowl locked together to be installed and removed as one piece from the manifold. The filter cartridge and bowl are joined together by application of a force in a single direction at a given time, that is, in a vertical direction. The bowl and filter cartridge are joined together by mating elements on the bowl and filter cartridge shaped so the elements are held together by friction which requires a force to decouple the bowl and filter cartridge. This construction permits the decoupling of the filtration cartridge and bowl from the manifold in two steps. In one embodiment, the coupling means can be constructed so that when it is desired to remove the filtration cartridge and bowl from the manifold, the filtration cartridge and bowl can be removed as one piece with a threaded locking ring.

### BRIEF DESCRIPTION OF THE DRAWINGS

FIG. 1 is a side view of a bowl and filter cartridge of the present invention.

FIG. 2 is a top perspective view of an attachment to form a bowl of this invention.

FIG. 3 is a side view of an alternative fitting for an attachment to form a bowl of this invention.

FIG. 4 is a cross sectional view of a bowl and filter cartridge of this invention fitted to a manifold.

FIG. 5 shows a first embodiment of the present invention for retaining the filter cartridge and bowl in a manifold in cross section.

FIG. 6 shows a second embodiment of the present invention for retaining the filter cartridge and bowl in a manifold in cross section.

FIG. 7 shows a further embodiment of the present invention for retaining the filter cartridge and bowl in a manifold in cross section.

FIG. 8 shows a further embodiment of the present invention for retaining the filter cartridge and bowl in a manifold in cross section.

### DESCRIPTION OF SPECIFIC EMBODIMENTS

The present invention provides a filtration module formed of a manifold, a filtration cartridge and a bowl. The manifold provides fluid pathways for fluid feed into the filtration cartridge and permeate removal from the filtration cartridge. The bowl provides a means of storing fluid feed to permit its introduction into the filtration cartridge or to store permeate from the filtration cartridge to be directed to the manifold and then from the filtration module. Fluid feed can be introduced into the filtration cartridge through the manifold either from the outside of the filtration cartridge or from within the interior of the filtration cartridge. The fluid in the bowl adjacent the filtration cartridge can be either fluid feed or permeate. In any event, the fluid feed is introduced from a manifold into the filtration module and permeate is removed from the filtration module from the manifold.

The filtration module and bowl are constructed so that they are sealed with the manifold or removed from contact with the manifold as one piece. Thus, the bowl and filtration module are formed from two pieces which are interlocked together by moving the bowl and filter cartridge in only one direction relative to each other at a given time. In a first connection step, the bowl and filter cartridge are moved in a vertical direction relative to each other. In a second connection step, the bowl and filter cartridge are moved in a horizontal direction relative to each other. To disconnect the bowl from the filter cartridge, these steps are reversed. After the bowl and filtration module are locked together they are connected to the manifold so that, during use in filtering of fluid, they do not become separated.

Subsequent to a filtration, the bowl and filtration module are removed from the manifold as a single piece rather than as two separate pieces. Since the bowl and filtration module are removed together, the filtration module need not be removed from the bowl. Thus, a space substantially equal to the length of the filtration module and the bowl together need not be provided. Only a space as long as substantially the length of the bowl need be provided. This permits one to install a filtration module of this invention within a smaller space as compared to the space required with present filtration modules. In addition, since the filtration module is removed with the bowl, it need not be handled by a worker either by hand or with a hand tool. Furthermore, any fluid positioned between the bowl and the filtration module upon completion of filtration need not be removed. This substantially reduces the possibility of contacting fluid within the bowl with a worker. Alternatively, the bowl could contain a drain for removing fluid before removal.

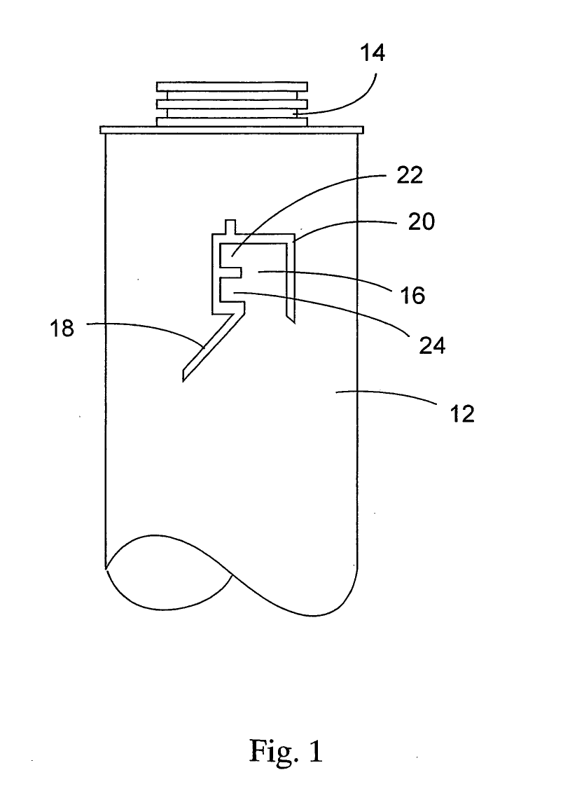

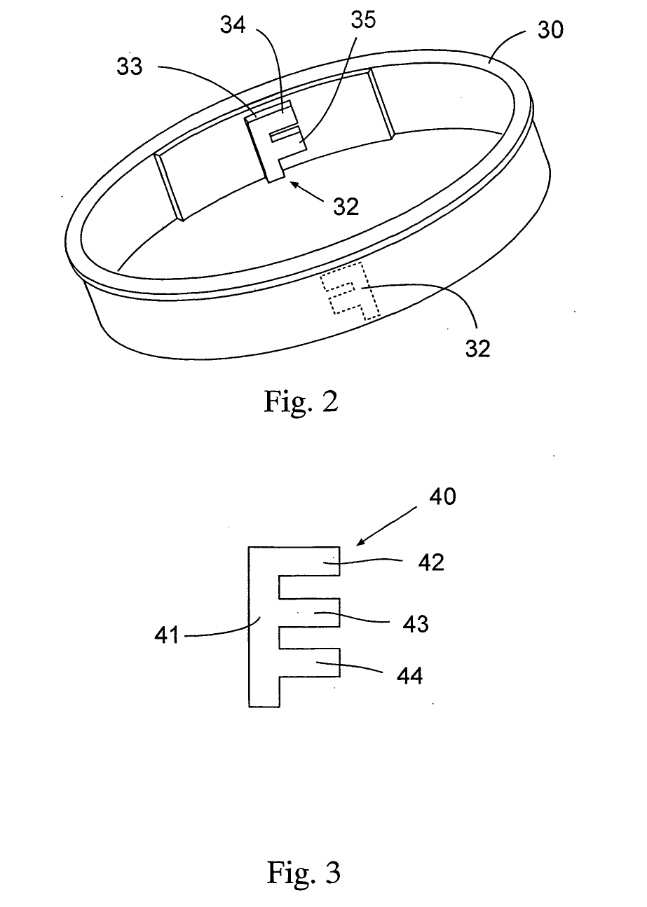

Referring to FIGS. 1 and 2, the filter cartridge 12 of this invention includes a filter such as a depth filter or a pleated filter and an inlet 14. The filter cartridge 12 includes a keyway 16 including an inclined surface 18, a vertical pathway 20 and two parallel horizontal pathways 22 and 24. The keyway 16 mates with a key which is molded to a ring 30 shown in FIG. 2.

Referring to FIG. 2, the ring 30 is constructed to fit onto a bowl (not shown). Alternatively, the ring 30 can be molded with the bowl to form a unitary construction. A key 32 is formed of a vertical section 33 and two horizontal sections 34 and 35 to form an F shape. The width of the combination of the vertical section 33 and each of horizontal sections 34 and 35 is slightly smaller than the vertical pathway 20 (FIG. 1). The height of the horizontal sections 34 and 35 is slightly smaller than the heights of horizontal pathways 22 and 24. To connect the keyway 16 and the key 32, the top surface of the key 32 slides along inclined surface 18 (FIG. 1) until the top of key 32 reaches the opening of vertical path 20, it is moved upwardly to the top of vertical path 20 after which the filter cartridge 12 is rotated so that horizontal sections 34 and 35 are moved into horizontal pathways 22 and 24. It is preferred that the surfaces of horizontal pathways 22 and 24 be roughened so that the horizontal sections 34 and 35 are retained therein by friction.

Referring to FIG. 3, an alternative key 40 is shown. The key 40 includes vertical section 41 and three horizontal sections 42, 43 and 44. The key 40 is fit into a keyway (not shown) having three horizontal pathways in the same manner described above with reference to key 32.

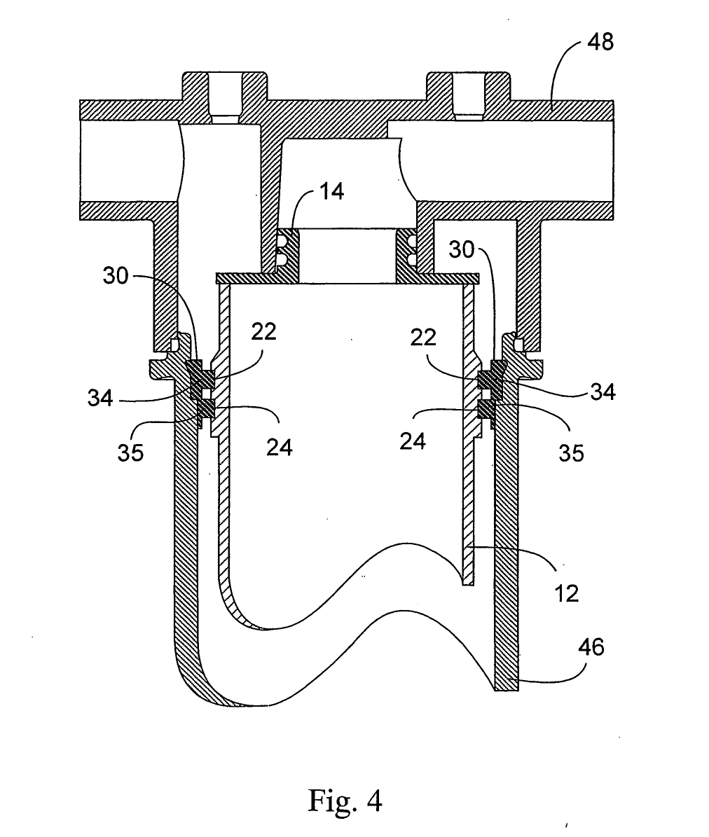

Referring to FIG. 4, the filter cartridge 12 having a keyway having horizontal sections 22 and 24 which mate with horizontal prongs 34 and 35 on ring 30 is positioned within bowl 46 and is retained therein by the cooperation of key 32 and keyway 16 which fit together as described above. The filter cartridge 12 and bowl 46 are fit into manifold 48.

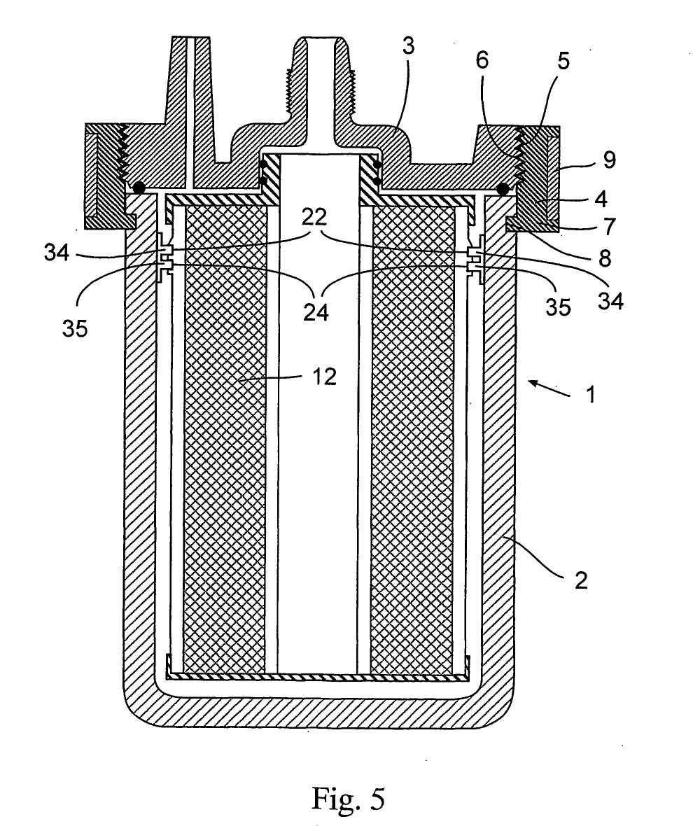

Referring to FIG. 5, there is shown a filter housing 1. The housing 1 is of a U line design, although the invention will work equally well with inline and other such housing designs. The housing 1 is formed of a bowl 2 and a manifold 3. A threaded ring 4 is substantially fixed in its position upon the bowl 2. The threads 5 of the ring 4 mate and thread easily with corresponding threads 6 formed on the manifold 3. The bowl 2 and filter cartridge 12 are joined together by horizontal sections 34 and 35 of a key 30 which fit into horizontal pathways 22 and 24 in the manner described above with reference to FIGS. 1 and 2.

In this embodiment as shown in the FIG. 5, the first component 2 is a cartridge bowl and the second component 3 is a manifold. As the ring 4 is substantially fixed in its position relative to the first component in this case the bowl 2, i.e. it cannot move any substantial distance along the length of the bowl 2. The ring 4 is loosely fixed on the bowl 3 so that it can be rotated by hand. When its threads 5 are mated to the corresponding threads 6 on the second component, in this case the manifold, 3 and the threads 5 and 6 are drawn together, the ring 4 carries or drives the first component or bowl 2 into affirmative contact with the second component or manifold 3. Conversely, when the ring 4 is rotated so as to drive the threads 5 and 6 apart, the first component or bowl 2 is positively carried or driven away from the second component or manifold 3.

The device used to fix the position of the ring 4 to one of the two components can be a variety of devices. As shown in FIG. 5, the ring 4 is loosely fixed to the first component 2, i.e. the bowl in this embodiment, using a key 7 formed on the ring 4 which key 7 mates and is held within a keyway 8 formed in the bowl 2. The ring 4 is shown with a knurled feature 9 on a portion of its outer side surface. The use of knurling or other such devices for providing an easy, slip-free surface to the ring is well known and may be used in this invention. Additionally, the use of lugs or tapered surfaces on the outer surface of the ring may be used to allow one to attach a wrench or other device for moving the ring relative to the other threaded component. While it is contemplated in the preferred embodiments of the present invention that no wrench or other device is necessary to move the ring, it is still within the scope of the present invention.

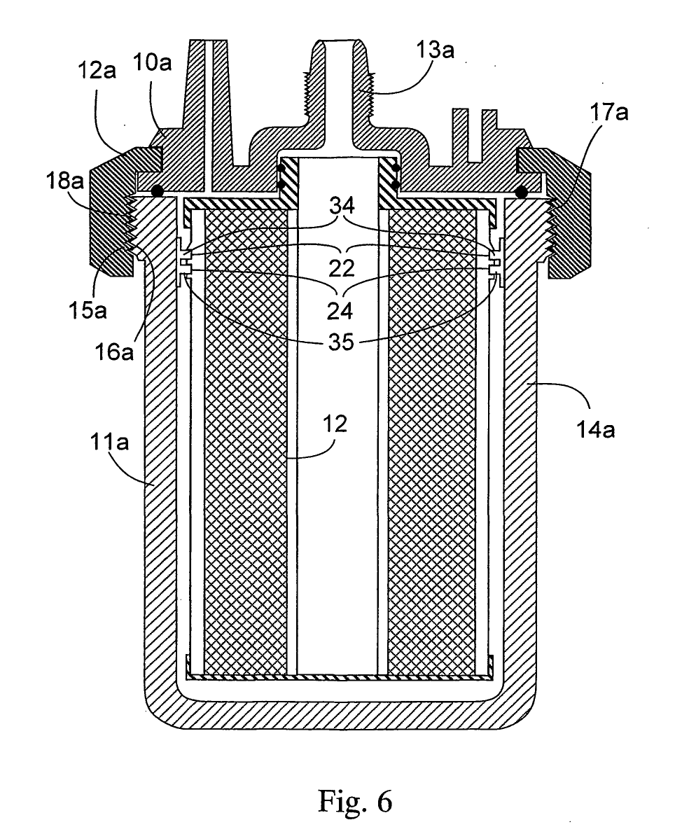

While the ring 4 is shown as being fixed to the bowl 2 in this embodiment, it may as easily be fixed to the manifold 3 as in FIG. 6 (the same numbers as in FIG. 5 apply where relevant in FIG. 2) Here the ring 12a is attached to the manifold 10a rather than the bowl 2 of FIG. 5. A keyway having horizontal paths 22 and 24 is formed in the surface 12a of the filter cartridge 12 and the key having the horizontal section 34 and 35 is trapped within it. The threads 18a of the ring 12a mate with the threads 17a of the bowl 17a to drive the manifold 12a and bowl 14a together and apart. The bowl 14a and filter cartridge 12 are joined together by horizontal sections of a key which fit into horizontal pathways 22 and 24 in the manner described above with reference to FIGS. 1 and 2.

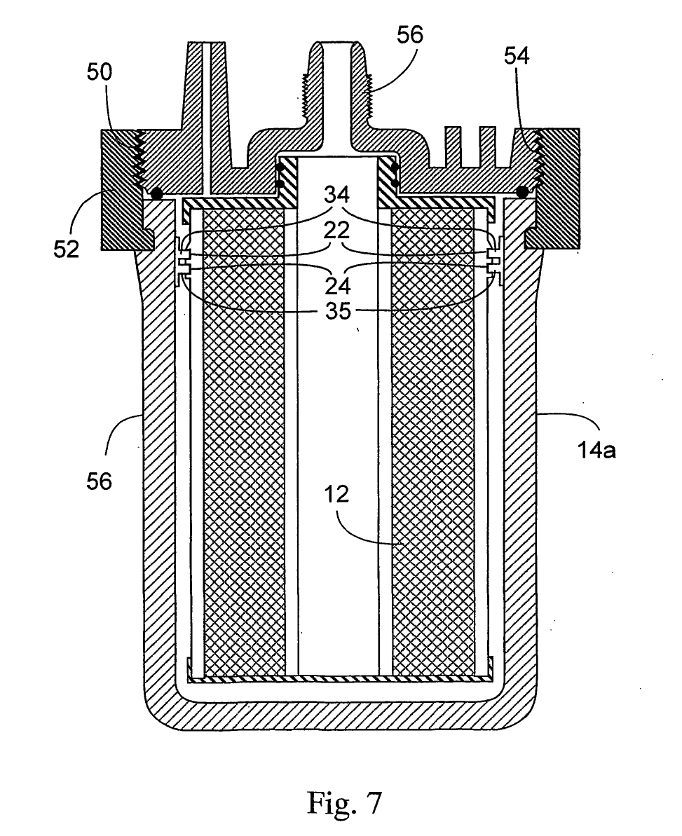

In FIG. 7 is shown an embodiment wherein the threads 50 of ring 52 mate with threads 54 of manifold 56. The ring 52 is mounted on bowl 56 in a manner so that it can be rotated by hand to drive the bowl 56 and filter cartridge 12 as a unit into and out of manifold 56 as described above. The bowl 56 and filter 12 are joined together by horizontal sections 34 and 35 which fit into horizontal paths 22 and 24 as described above.

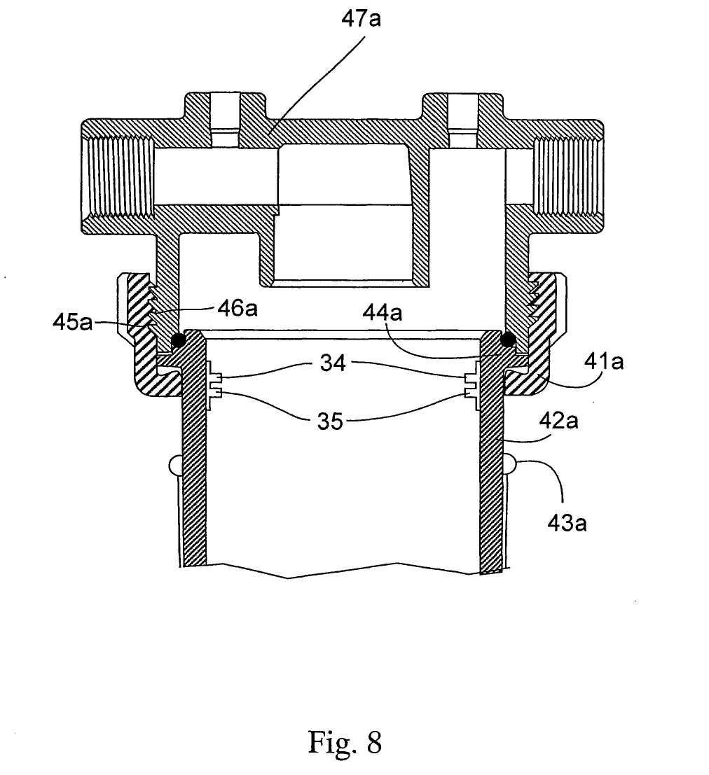

FIG. 8 shows a further embodiment of the present invention and clearly demonstrates what is meant by the term “substantially fixed”. In this embodiment, the ring 41a is mounted to the bowl 42a and retained to the bowl 42a by a ridge 43a, which in this embodiment is a circular ring positioned along a portion of the outer surface of the side wall of the bowl 42a. The bowl 42a also has a lip 44a which extends outward from the upper portion of the outside surface of the side wall of the bowl 42a. The threads 45a of the ring 41a mate with the threads 46a of the manifold 47a.

As can be seen, there is substantial room between the lip 44a and the ridge 43a along the length of the side wall of the bowl 42a. Yet, this embodiment still shows the ring 41a being in a substantially fixed position relative to the bowl 42a. By the term “substantially fixed”, it is meant that the ring is retained to one component of the housing in such a manner that its travel along the length of the component is less than 50% of that length. Preferably, the amount of travel allowed to the ring relative to the length of the component is less than 25% of the component length.

In other terms, the length of travel of the ring relative to the length of the component should be such that at least for a portion of the rotation of the threads between the ring and the second component, there is a driving force caused by the threads of the ring to move the components affirmatively. Preferably, the length of travel is limited such that the threads of the ring will begin to rotate against those of the other component for some set (as desired by the manufacturer) distance before the ring threads are in a position to positively drive the two components together or apart. In this way, one is staggering the load placed upon the ring making its use easier, quicker and simpler.

Alternatively, one can use other devices should as band clamps, lugs, etc to retain the ring in its desired substantially fixed position relative to the component to which it is mounted. The device used to retain the ring in a substantially fixed position relative to the component to which it is attached is not critical so long as it allows the two components to adequately move relative to each other to form a liquid tight seal and to allow the ring to retained in a manner so that it affirmatively drives the two components at least a portion of the way together and apart as desired.

The selection of filtration media used within the filtration cartridge can be any of those commonly used in the industry. Typically, the media includes but is not limited to of flat sheet membrane, spiral wound flat sheet membrane, pleated flat sheet membrane, spiral pleated flat sheet membrane, hollow fiber membrane, depth filter media such as spiral wound continuous fiber depth filter media, sintered metal filter media, ceramic media, particulate media containing an active capture material such as resin or ceramic beads or a membrane with ligands for removing selected materials from the fluid attached to their surfaces, ion exchange media such as anion resin, cation resin or mixtures of the two alone or incorporated into a membrane structure and combinations of any of these.

Lastly, in all of these embodiments the bowl and manifold may be made of a plastic, preferably a thermoplastic including polyolefins such as polyethylenes including ultrahigh molecular weight polyethylenes, polypropylenes; copolymers or terpolymers of polyolefins; nylons; PTFE resin, PFA, PVDF, ECTFE, and other fluorinated resins, particularly perfluorinated thermoplastic resins; polycarbonates; metallocene derived polymers, polysulphones; modified polysulphones such as polyethersulphone, polyarylsulphones or polyphenylsulphones; any glass or other reinforced plastic; or a metal such as stainless steel, aluminum, copper, bronze, brass, nickel, chromium or titanium or alloys or blends thereof.

1. A filtration module which comprises a manifold, a filtration cartridge and a bowl having a vertical axis which houses the filter cartridge,
the manifold having a series of threads formed on its outer surface, the bowl having a ring with threads on its inner surface which mate with the threads of the manifold, the ring being rotatable with respect to the bowl and being secured to the bowl so as to maintain a substantially fixed position on the vertical axis of the bowl and a filter cartridge contained within the bowl,
said filter cartridge being positively secured to the bowl so that said filter cartridge travels with the bowl into said manifold or from said manifold when said ring is rotated,
said filtration cartridge being positively secured to the bowl by at least one keyway on an outside surface of said filtration cartridge which mates with at least one key on an inside surface of said bowl,
said filtration cartridge being in fluid communication with said manifold in a manner which prevents mixing of a fluid feed to said filtration cartridge with a permeate removed from said filtration cartridge.

2. The filtration module of claim 1 which includes an inlet for fluid feed to said bowl and an outlet for permeate from said filtration cartridge.

3. The filtration module of claim 1 which includes an inlet for fluid feed to said filtration cartridge and an outlet for permeate from said bowl.

4. The filtration module of claim 1 wherein the filtration cartridge contains one or more filtration media selected from the group consisting of flat sheet membrane, spiral wound flat sheet membrane, pleated flat sheet membrane, spiral pleated flat sheet membrane, hollow fiber membrane, depth filter media, particulate media containing an active capture material, ion exchange media, and combinations thereof.

5. The filtration module of anyone of claims 1, 2, 3 or 4 wherein said keyway has a vertical section and at least two horizontal sections connected to said vertical sections.

6. The filtration module of claim 5, wherein said keyway has two horizontal sections.

7. The filtration module of claim 5, wherein said keyway includes an inclined surface connected said vertical section.

8. The filtration module of claim 6, wherein said keyway includes an inclined surface connected to said vertical section.

9. A filtration module which comprises a manifold having a vertical axis, a filtration cartridge and a bowl which houses the filter cartridge,
the bowl having a series of threads formed on its outer surface, the manifold having a ring with threads on its inner surface which mate with the threads of the bowl, the ring being rotatable with respect to the manifold and being secured to the manifold and a filter cartridge contained with the bowl,
said filter cartridge being positively secured to the bowl so that said filter cartridge travels with the bowl into said manifold or from said manifold when said ring is rotated,
said filtration cartridge being positively secured to the bowl by at least one keyway on an outside surface of said filtration cartridge which mates with at least one key on an inside surface of said bowl,
said filtration cartridge and bowl being in fluid communication with said manifold in a manner which prevents mixing of a fluid feed to said filtration cartridge with a permeate removed from said filtration cartridge.

10. The filtration module of claim 1 which includes an inlet for fluid feed to said bowl and an outlet for permeate from said filtration cartridge.

11. The filtration module of claim 1 which includes an inlet for fluid feed to said filtration cartridge and an outlet for permeate from said filtration cartridge.

12. The filtration module of claim 1 wherein the filtration cartridge contains one or more filtration media selected from the group consisting of flat sheet membrane, spiral wound flat sheet membrane, pleated flat sheet membrane, spiral pleated flat sheet membrane, hollow fiber membrane, depth filter media, particulate media containing an active capture material, ion exchange media, and combinations thereof.

13. The filtration module of any one of claims 1, 2, 3 or 4 wherein said keyway has a vertical section and at least two horizontal sections connected to said vertical sections.

14. The filtration module of claim 5, wherein said keyway has two horizontal sections.

15. The filtration module of claim 5, wherein said keyway includes an inclined surface connected to said vertical section.

16. The filtration module of claim 6, wherein said keyway includes an inclined surface connected to said vertical section.
